(19) United States
(12) Patent Application Publication
(10) Pub. No.: US 2010/0246356 A1
(43) Pub. Date: Sep. 30, 2010

(54) DISK SURFACE DEFECT INSPECTION METHOD AND APPARATUS

(75) Inventors: Bin Abdulrashid FARIZ, Kamisato (JP); Yu YANAKA, Kamisato (JP); Keiji KATO, Kamisato (JP); Takayuki ISHIGURO, Kamisato (JP); Shigeru SERIKAWA, Kamisato (JP)

Correspondence Address: BRUNDIDGE & STANGER, P.C., 2318 MILL ROAD, SUITE 1020, ALEXANDRIA, VA, 22314, US

(73) Assignee: HITACHI HIGH-TECHNOLOGIES CORPORATION, Tokyo (JP)

(21) Appl. No.: 12/719,598

(22) Filed: Mar. 8, 2010

(30) Foreign Application Priority Data
Mar. 31, 2009 (JP) 2009-084382

(51) Int. Cl. G11B 20/18

(52) U.S. Cl. 369/53.22; G9B/20.046

(57) ABSTRACT

The present invention provides a disk surface defect inspection method including: irradiating a laser beam from an oblique direction onto a disk surface being rotated; detecting intensities of a first light that is scattered with low-angle and a second light that is scattered with high-angle from minute concave and convex defects; determining that a defect is the minute convex defect if a ratio of the intensity of the first light to the intensity of the second light is constant; and determining that a defect is the minute concave defect if the ratio of the intensity of the first light to the intensity of the second light is changed.

### CLAIM OF PRIORITY

The present application claims priority from Japanese application serial no. JP2009-084382, filed on Mar. 31, 2009, the content of which is hereby incorporated by reference into this application.

### BACKGROUND OF THE INVENTION

1. Field of the Invention

The present invention relates to a disk surface defect inspection method and apparatus by which a defect on a disk surface is optically detected to determine the type of the defect, and particularly to a disk surface defect inspection method and apparatus by which minute concave and convex defects with a size of about 1 μm are discriminated.

2. Description of the Related Art

As a magnetic recording medium used for a hard disk device, a magnetic disk having a magnetic material vapor-deposited on a disk substrate is used. Magnetic information is recorded or reproduced into/from the magnetic disk through a magnetic head. With an increasing recording density in a hard disk device in recent years, a spacing (floating distance) between the magnetic head and the magnetic disk is narrowed down to as small as several tens of nm to a few nm.

Therefore, if a convex defect larger than the floating distance is present on the disk substrate, the magnetic disk and the magnetic head are brought into contact with each other to cause trouble in the hard disk device. In order to improve the yield ratio of the magnetic disk, it is important that the presence or absence of the defect is inspected in a state before the magnetic material is vapor-deposited so as not to pass on a defective product to the subsequent step. In addition to the large convex defect, a concave defect is also a problem.

Japanese Patent Application Laid-Open No. 2008-268189 discloses a surface defect inspection method and apparatus by which scattered light and specular light from a disk substrate are detected at the same time so as to detect foreign substances, scratches, bump defects, and pit defects on a substrate surface, and specular light is detected so as to reliably detect the signal level of a defect by reducing the impact of wave-like distortion of the entire substrate or local wave-like distortion.

Japanese Patent Application Laid-Open No. 2001-066263 discloses that a condensing unit with a small solid angle capable of condensing scattered light only in a predetermined narrow range is arranged on the same axis as a laser beam irradiated from a projector system at an elevation angle in accordance with the directivity of predetermined scattered light, so that the condensing unit with a small solid angle can receive only the scattered light with sharp directivity in a narrow range and a circle scratch defect can be intensively detected.

In the above-described conventional method, a concave defect and a foreign substance are discriminated based on misalignment of the center of the specular light, and the size thereof is about 5 μm. Thus, it is difficult to discriminate minute concave and convex defects with a size of about 1 μm. This is because if a light receiving unit receives reflective light from a minute defect with a size of about 1 μm, the wave height value of the defect becomes out of range due to high sensitivity of a light receiver of a conventional detecting system. As described above, with an increasing recording density in a hard disk device in recent years, the spacing (floating distance) between the magnetic head and the magnetic disk is narrowed down to as small as several tens of nm to a few nm. Accordingly, it is an important problem to be solved to discriminate and detect the minute concave and convex defects with a size of about 1 μm on a surface of a disk substrate (simply referred to as a disk in some cases).

### SUMMARY OF THE INVENTION

An object of the present invention is to discriminate minute concave and convex defects with a size of about 1 μm on a disk surface, which has been difficult to discriminate by a conventional method.

In order to achieve the above-described object, the present invention provides a disk surface defect inspection method including the steps of: irradiating a laser beam an oblique direction onto a disk surface being rotated from; detecting intensities of a first light that is scattered with low-angle and a second light that is scattered with high-angle from minute concave and convex defects; determining that a defect is the minute convex defect if a ratio of the intensity of the first light to the intensity of the second light is constant; and determining that a defect is the minute concave defect if the ratio of the intensity of the first light to the intensity of the second light is changed.

A depth of the minute concave defect is about 1 μm, and a height of the minute convex defect is about 1 μm.

In the case where the ratio of the intensity of the first light to the intensity of the high-angled scattered light is changed, the intensity of the second light is decreased as compared to the intensity of the first light.

The disk is a magnetic disk before a magnetic layer is formed.

The first light is scattered at a smaller angle than the second light on the basis of an axis that is orthogonal to the disk surface.

In order to achieve the above-described object, the present invention provides a disk surface defect inspection apparatus including: a laser light source which irradiates a laser beam from an oblique direction onto a disk surface being rotated; a first optical receiver which receives a first light that is scattered with low-angle from the disk surface; a second optical receiver which receives the first light with lower sensitivity than the first optical receiver; a third optical receiver which receives a second light that is scattered with high-angle from the disk surface; a fourth optical receiver which receives the second light with lower sensitivity than the third optical receiver; and a controller which obtains a ratio of an output of the second optical receiver to an output of the fourth optical receiver, determines that a defect is a minute convex defect if the ratio of the output of the second optical receiver to the output of the fourth optical receiver is constant, and determines that the defect is a minute concave defect if the ratio of the output of the second optical receiver to the output of the fourth optical receiver is changed.

A depth of the minute concave defect is about 1 μm, and a height of the minute convex defect is about 1 μm.

In the case where the ratio of the output of the second optical receiver to the output of the fourth optical receiver is changed, the output intensity of the fourth optical receiver is decreased as compared to the output intensity of the second optical receiver.

The second optical receiver has sensitivity characteristics of the first light from the concave and convex defects with a size of about 1 μm of the disk surface, and the fourth optical receiver has sensitivity characteristics of the second light from the concave and convex defects with a size of about 1 μm of the disk surface.

The first optical receiver is arranged at a position with an angle smaller than the third optical receiver on the basis of an axis orthogonal to the disk surface, and the second optical receiver is arranged at a position with an angle smaller than the fourth optical receiver on the basis of an axis orthogonal to the disk surface.

In order to achieve the above-described object, the present invention provides a disk surface defect inspection apparatus including: a laser light source which irradiates a laser beam from an oblique direction onto a disk surface being rotated; a first optical system which allows a first light that is scattered with low-angle by the laser beam from the disk surface to pass through or reflect; a first optical receiver which receives the first light which passes through the first optical system; a second optical receiver which receives the first light with sensitivity lower than the first optical receiver, the second optical receiver receiving the first light which is reflected by the first optical system; a second optical system which allows a second light that is scattered with high-angle by the laser beam from the disk surface to pass through or reflect; a third optical receiver which receives the second light which passes through the second optical system; a fourth optical receiver which receives the second light with sensitivity lower than the third optical receiver, the fourth optical receiver receiving the second light which is reflected by the second optical system; and a controller which obtains a ratio of an output of the second optical receiver to an output of the fourth optical receiver, determines that a defect is a minute convex defect if the ratio of the output of the second optical receiver to the output of the fourth optical receiver is constant, and determines that the defect is a minute concave defect if the ratio of the output of the second optical receiver to the output of the fourth light optical receiver is changed.

In the case where the ratio of the output of the second optical receiver to the output of the fourth optical receiver is changed, the output intensity of the fourth optical receiver is decreased as compared to the output intensity of the second optical receiver.

The second optical receiver has sensitivity characteristics of the first light from the concave and convex defects with a size of about 1 μm of the disk surface, and the fourth optical receiver has sensitivity characteristics of the second light from the concave and convex defects with a size of about 1 μm of the disk surface.

The first optical receiver is arranged at a position with an angle smaller than the third optical receiver on the basis of an axis orthogonal to the disk surface, and the second optical receiver is arranged at a position with an angle smaller than the fourth optical receiver on the basis of an axis orthogonal to the disk surface.

According to the present invention, it is possible to discriminate and detect minute concave and convex defects with a size of about 1 μm on a disk surface.

### BRIEF DESCRIPTION OF THE DRAWINGS

FIG. 1 shows a conceptual view of a disk surface defect inspection apparatus according to an embodiment of the present invention;

FIG. 2 is a diagram showing a discrimination method of minute concave and convex defects in the disk surface defect inspection method according to the present invention;

FIGS. 3A and 3B are diagrams, each showing a state in which scattered light is generated from a foreign substance when illuminated from an oblique direction;

FIGS. 4A and 4B are diagrams, each showing a state in which the scattered light is generated from a concave defect when illuminated from an oblique direction; and

FIG. 5 is a diagram showing a simulated result of the intensity of the scattered light from a foreign substance and a modeled concave in a light system and a dark system.

### DETAILED DESCRIPTION OF THE EMBODIMENT

First of all, characteristics of the intensity of scattered light caused by concave and convex portions using a scattered light optical system will be described. The patterns of the scattered light generated differ depending on the shapes of object defects.

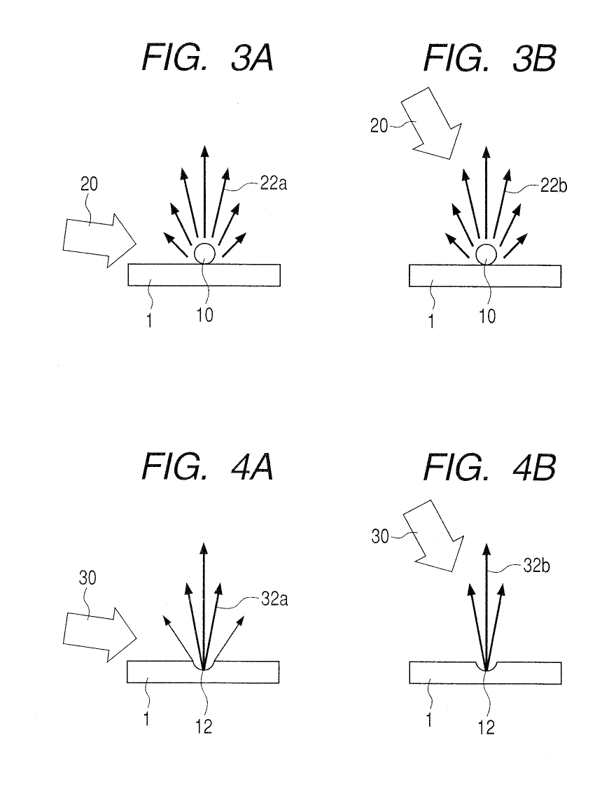

FIGS. 3A to 4B are diagrams, each showing a state in which the scattered light is generated from a foreign substance and a concave defect when being illuminated from an oblique direction. FIGS. 3A and 3B are diagrams, each showing a state in which the scattered light is generated from a convex defect 10 such as a foreign substance existing on a surface of a disk substrate (disk) 1. FIG. 3A shows a case where the disk is obliquely illuminated from the left side, and FIG. 3B shows a state viewed from a direction orthogonal to the illumination direction shown in FIG. 3A. When illumination light 20 is illuminated onto the disk substrate 1 from an oblique direction, scattered light 22a and 22b is generated from the foreign substance 10 as the illustrated distribution. As described above, it is common that the scattered light from the projection such as the foreign substance 10 is symmetrically distributed as shown in FIG. 3B. As an exceptional case, however, the scattered light is not symmetrically distributed depending on illumination conditions and the size of the foreign substance.

FIGS. 4A and 4B are diagrams, each showing a state in which the scattered light is generated from a scratched defect 12 such as a concave defect existing on the surface of the disk substrate 1. FIG. 4A shows a case where the disk is obliquely illuminated from the left side, and FIG. 4B shows a state viewed from a direction orthogonal to the illumination direction shown in FIG. 4A. When illumination light 30 is illuminated onto the disk substrate 1 from an oblique direction, scattered light 32a and 32b is generated as the illustrated distribution. The amount of the reflective scattered light 32a generated is large in a direction orthogonal to the scratch 12, whereas the amount of the reflective scattered light 32b generated is small in the scratch direction as shown in FIG. 4B.

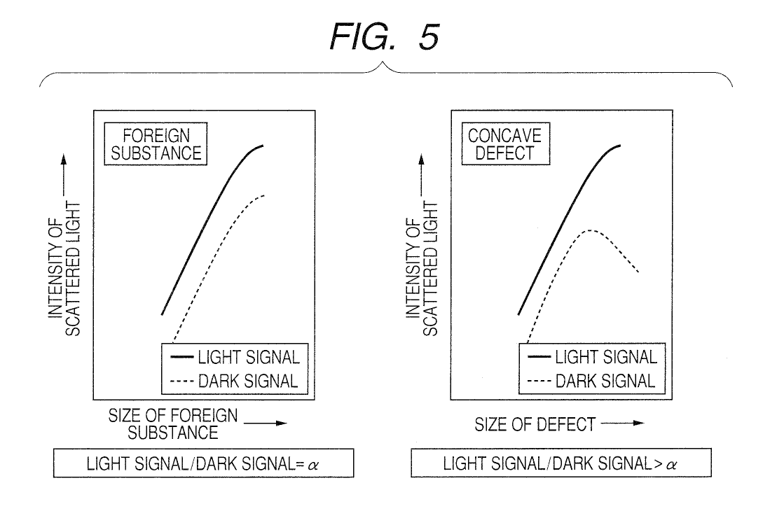

FIG. 5 shows a simulated result of the intensity of the scattered light from the foreign substance and a modeled concave in a system that receives a light that is scattered with low-angle (light system) and a system that receives a light that is scattered high-angle (dark system). It has been found that a ratio α of a light signal to a dark signal is always the same in the case of the foreign substance, whereas the ratio α is gradually increased depending on the size of the defect in the case of the concave defect larger than a certain size. According to the present invention, the concave defect and the convex defect are discriminated by using the characteristics of the intensity of the scattered light due to the defect shape. In a conventional detection system, the wave height value of a defect becomes out of range due to the high sensitivity of a light receiver. Thus, the characteristics can not be obtained, and the concave defect and the convex defect can not be discriminated. Accordingly, the present invention additionally provides light receivers of the light system and the dark system in which the level of sensitivity is reduced to the extent that the characteristics can be obtained.

FIG. 1 shows a conceptual view of a disk surface defect inspection apparatus according to an embodiment of the present invention. As shown in FIG. 1, additional light receiving systems with low sensitivity are provided for the light system (for detection) and the dark system (for detection) of the conventional apparatus by branching the scattered light at reflective mirrors to discriminate the minute concave defect and the minute convex defect. The configuration will be described as follows. The disk surface defect inspection apparatus includes a laser source (projector) 2 which irradiates a laser beam from an oblique direction onto the surface of the disk substrate 1 being rotated, a first light receiver 5a of a light-system (for detection) that receives a light of the laser beam that is scattered with low-angle from the surface of the disk substrate 1 through lenses 3a and 3b and a reflective mirror 4a, a second light receiver 5b of the light-system (for discrimination) with sensitivity lower than the first light receiver 5a, which receives the light of the laser beam from the surface of the disk substrate 1 through the lenses 3a and 3b and the reflective mirror 4a, a third light receiver 6a of a dark-system (for detection) that receives a light of the laser beam that is scattered with high-angle from the surface of the disk substrate 1 through lenses 3c and 3d and a reflective mirror 4b, and a fourth light receiver 6b of a dark-system (for discrimination) with sensitivity lower than the third light receiver 6a, which receives the light of the laser beam from the surface of the disk substrate 1 through the lenses 3c and 3d and the reflective mirrors 4b and 4c. Here, the second light receiver 5b and the fourth light receiver 6b are reduced in sensitivity level to the extent that the characteristics of the scattered light shown in FIG. 5 can be obtained. A controller 100 includes an operation unit such as a CPU (Central Processing Unit) and a memory. Upon receiving output signals from the second light receiver 5b and the fourth light receiver 6b, the controller 100 performs a process of discriminating the minute concave and convex defects. The detailed content of the process will be described later. It should be noted that an angle in each of the first light receiver, the second light receiver, the third light receiver, and the fourth light receiver is based on an axis in the direction orthogonal to the disk surface and is shown by θ1 or θ2 in FIG. 1. Specifically, θ1<θ2 is satisfied in a relation between the angle (θ1) where the first light receiver and the second light receiver are arranged and the angle (θ2) where the third light receiver and the fourth light receiver are arranged. Thus the first light receiver is arranged at a position with an angle smaller than the third light receiver on the basis of an axis orthogonal to the disk surface, and the second light receiver is arranged at a position with an angle smaller than the fourth light receiver on the basis of an axis orthogonal to the disk surface.

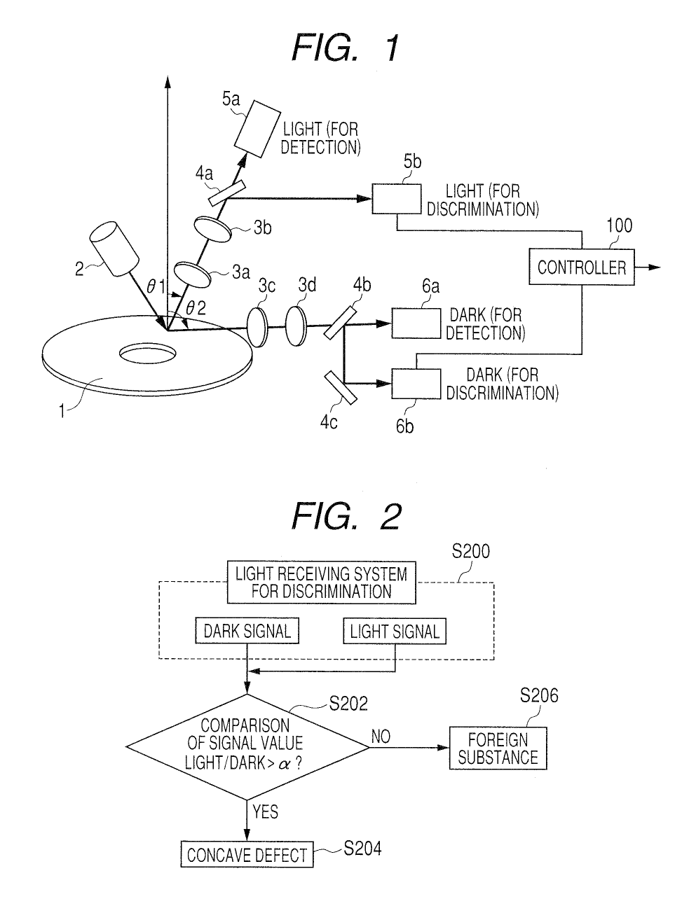

According to the configuration shown in FIG. 1, the laser beam is irradiated from the laser light source 2 onto the surface of the disk substrate 1 being rotated, and the scattered light is received by the first light receiver 5a and the third light receiver 6a, so that the concave and convex defects with a size larger than 1 μm on the disk substrate 1 can be discriminated and detected on the basis of outputs from the first light receiver 5a and the third light receiver 6a. The minute concave and convex defects with a size of about 1 μm can be discriminated and detected by performing a process shown in FIG. 2. In FIG. 2, the laser beam is irradiated from the laser light source 2 onto the surface of the disk substrate 1 being rotated, the scattered light is received by the second light receiver 5b and the fourth light receiver 6b, and a light signal as an output from the second light receiver 5b and a dark signal as an output from the fourth light receiver 6b are obtained (step 200). Next, a ratio of the light signal to the dark signal is set as a threshold value α, and it is determined whether the ratio of the light signal to the dark signal corresponds to a or is changed (larger than α) (step 202). In the case where the ratio of the light signal to the dark signal is larger than α, the defect is discriminated as the concave defect (step 204). Further, in the case where the ratio of the light signal to the dark signal corresponds to α, the defect is discriminated as the foreign substance (step 206). It should be noted that the processes of S200 to S206 such as setting of the threshold value and the determination on whether the ratio of the light signal to the dark signal is constant (α) or is changed are performed by the controller 100. When the process of the step S204 or S206 is completed, the controller 100 outputs the result to an external device (for example, display device (not shown) such as a monitor).

As described above, according to the embodiment of the present invention, the minute concave and convex defects with a size of about 1 μm on the disk surface can be discriminated and detected. Further, only the light receiving systems for discriminating the minute concave and convex defects with a size of about 1 μm are added to those of the conventional disk surface defect inspection apparatus. Accordingly, such a configuration can minimize an increase in cost and can discriminate and detect the minute defects without decreasing the conventional inspection function.

The present invention is useful in application to the disk surface defect inspection apparatus because the minute concave and convex defects with a size of about 1 μm on the disk surface can be discriminated and detected.

What is claimed is:

1. A disk surface defect inspection method comprising:
irradiating a laser beam from an oblique direction onto a disk surface being rotated;
detecting intensities of a first light that is scattered with low-angle and a second light that is scattered with high-angle from minute concave and convex defects;
determining that a defect is the minute convex defect if a ratio of the intensity of the first light to the intensity of the second light is constant; and
determining that a defect is the minute concave defect if the ratio of the intensity of the first light to the intensity of the second light is changed.

2. The disk surface defect inspection method according to claim 1, wherein a depth of the minute concave defect is about 1 μm, and a height of the minute convex defect is about 1 μm.

3. The disk surface defect inspection method according to claim 1, wherein in the case where the ratio of the intensity of the first light to the intensity of the second light is changed, the intensity of the second light is decreased as compared to the intensity of the first light.

4. The disk surface defect inspection method according to claim 1, wherein the disk is a magnetic disk before a magnetic layer is formed.

5. The disk surface defect inspection method according to claim 1, wherein the first light is scattered at a smaller angle than the second light on the basis of an axis that is orthogonal to the disk surface.

6. A disk surface defect inspection apparatus comprising:
a laser light source which irradiates a laser beam from an oblique direction onto a disk surface being rotated;
a first optical receiver which receives a first light that is scattered with low-angle from the disk surface;
a second optical receiver which receives the first light with lower sensitivity than the first optical receiver;
a third optical receiver which receives a second light that is scattered with high-angle from the disk surface;
a fourth optical receiver which receives the second light with lower sensitivity than the third optical receiver; and
a controller which obtains a ratio of an output of the second optical receiver to an output of the fourth optical receiver, determines that a defect is a minute convex defect if the ratio of the output of the second optical receiver to the output of the fourth optical receiver is constant, and determines that the defect is a minute concave defect if the ratio of the output of the second optical receiver to the output of the fourth optical receiver is changed.

7. The disk surface defect inspection apparatus according to claim 6, wherein a depth of the minute concave defect is about 1 μm, and a height of the minute convex defect is about 1 μl.

8. The disk surface defect inspection apparatus according to claim 6, wherein in the case where the ratio of the output of the second optical receiver to the output of the fourth optical receiver is changed, the output intensity of the fourth optical receiver is decreased as compared to the output intensity of the second optical receiver.

9. The disk surface defect inspection apparatus according to claim 6, wherein the second optical receiver has sensitivity characteristics of the first light from the concave and convex defects with a size of about 1 μm of the disk surface, and the fourth optical receiver has sensitivity characteristics of the second light from the concave and convex defects with a size of about 1 μm of the disk surface.

10. The disk surface defect inspection apparatus according to claim 6, wherein the first optical receiver is arranged at a position with an angle smaller than the third optical receiver on the basis of an axis orthogonal to the disk surface, and the second optical receiver is arranged at a position with an angle smaller than the fourth optical receiver on the basis of an axis orthogonal to the disk surface.

11. A disk surface defect inspection apparatus comprising:
a laser light source which irradiates a laser beam from an oblique direction onto a disk surface being rotated;
a first optical system which allows a first light that is scattered with low-angle by the laser beam from the disk surface to pass through or reflect;
a first optical receiver which receives the first light which passes through the first optical system;
a second optical receiver which receives the first light with sensitivity lower than the first optical receiver, the second optical receiver receiving the first light which is reflected by the first optical system;
a second optical system which allows a second light that is scattered with high-angle by the laser beam from the disk surface to pass through or reflect;
a third optical receiver which receives the second light which passes through the second optical system;
a fourth optical receiver which receives the second light with sensitivity lower than the third optical receiver, the fourth optical receiver receiving the second light which is reflected by the second optical system; and
a controller which obtains a ratio of an output of the second optical receiver to an output of the fourth optical receiver, determines that a defect is a minute convex defect if the ratio of the output of the second optical receiver to the output of the fourth optical receiver is constant, and determines that the defect is a minute concave defect if the ratio of the output of the second optical receiver to the output of the fourth light optical receiver is changed.

12. The disk surface defect inspection apparatus according to claim 11, wherein in the case where the ratio of the output of the second optical receiver to the output of the fourth optical receiver is changed, the output intensity of the fourth optical receiver is decreased as compared to the output intensity of the second optical receiver.

13. The disk surface defect inspection apparatus according to claim 11, wherein the second optical receiver has sensitivity characteristics of the first light from the concave and convex defects with a size of about 1 μm of the disk surface, and the fourth optical receiver has sensitivity characteristics of the second light from the concave and convex defects with a size of about 1 μm of the disk surface.

14. The disk surface defect inspection apparatus according to claim 11, wherein the first optical receiver is arranged at a position with an angle smaller than the third optical receiver on the basis of an axis orthogonal to the disk surface, and the second optical receiver is arranged at a position with an angle smaller than the fourth optical receiver on the basis of an axis orthogonal to the disk surface.
